(19) United States
(12) Patent Application Publication
(10) Pub. No.: US 2014/0125867 A1
(43) Pub. Date: May 8, 2014

(54) Methods and Apparatuses for Providing Automatic Interactive Area of Visability Video Zooming for Low Light Environments

(71) Applicant: NOKIA CORPORATION, Espoo (FI)

(72) Inventors: Igor Danilo Diego Curcio, Tampere (FI); Sujeet S. Mate, Tampere (FI)

(73) Assignee: Nokia Corporation, Espoo (FI)

(21) Appl. No.: 13/668,911

(22) Filed: Nov. 5, 2012

(51) Int. Cl. H04N 5/262

(52) U.S. Cl. CPC H04N 5/2628
USPC 348/581

(57) ABSTRACT

A method of performing automatic interactive area of visibility video zooming for low light environments is provided. The method includes defining a first set of candidate frame perimeters comprising a subset of one or more frames of recorded video based upon a cropping threshold for cropping the one or more frames; determining a first brightness value within the first set of candidate frame perimeters for the one or more frames; in response to the first brightness value being above a minimum brightness threshold, not displaying all content outside of the first set of candidate frame perimeters; in response to the first brightness value being at or below the minimum brightness threshold, defining a second set of candidate frame perimeters which comprise a subset of the first set of candidate frame perimeters, and determining a second brightness value within the second set of candidate frame perimeters.

### TECHNOLOGICAL FIELD

Embodiments of the present invention relate generally to content sharing technology and, more particularly, to methods and apparatuses for providing automatic interactive area of visibility video zooming for low light environments.

### BACKGROUND

The modern communications era has brought about a tremendous expansion of wireline and wireless networks. Computer networks, television networks, and telephony networks are experiencing unprecedented levels of technological expansion. Wireless and mobile networking technologies have addressed growing consumer demand while providing enhanced flexibility and immediacy of information transfer.

Current and future networking technologies continue to facilitate ease of information transfer and convenience to users by expanding the capabilities of mobile electronic devices. One area in which there is a demand to increase ease of information transfer relates to the sharing of information between multiple devices and multiple users. Given the capability of modern electronic devices to create and modify content, and also to distribute and share content, it is not uncommon for users of such devices to become prolific consumers and producers of media content. Networks and services have been developed to enable users to move created content to various points within the network, and also to experience content at various points within the network.

Various applications and software have also been developed and continue to be developed to perform tasks, communicate, obtain information and services, and provide entertainment in fixed as well as mobile environments. Given the robust capabilities of mobile electronic devices and the relatively small size of such devices, it is becoming increasingly common for individuals to keep mobile electronic devices on or near their person on a nearly continuous basis. Moreover, because such devices are useful for work, play, leisure, entertainment, and other purposes, many users also interact with their devices on a frequent basis. Accordingly, whether interaction occurs via a mobile electronic device or a fixed electronic device (e.g., a personal computer (PC)), more and more people are interacting with friends, colleagues and acquaintances via online networks. This trend has led to the rise of a number of social networking applications that span the entire spectrum of human interaction from purely professional to purely leisure activities and everything in between. Individuals in various groups may generate large amounts of content to be shared with others. Thus, it may be desirable to develop continued improvements regarding the manner by which content may be generated and shared amongst individuals.

Multimedia capturing capabilities have become commonplace in mobile phones. This has generated a large market for people who want to record or capture media at an event that they are attending, despite the fact that professional alternative sources of event-related content may be available. It continues to be the case that people depend on their own captured content for the vast majority of events and social functions rather than using a professional source. Hence it can be safely assumed that the share of user generated content is expanding rapidly.

People capture video content using mobile devices in a wide variety of environments. Some of these environments, such as bars, night clubs and concerts, may involve low-light situations. This often results in videos that include a bright or clearly visible central area corresponding to the stage, for example, where the central area is surrounded by a dark and poorly lit peripheral area. The brighter or more clearly visible central area often includes one or more objects that are of interest to viewers. By contrast, it is often difficult or impossible for viewers to determine whether or not the dark areas of the video include any useful content.

In some situations, post-processing techniques have been employed to increase the brightness of a recorded video. Post-processing a recorded video to identify dark areas requires the recorded video to be decoded prior to performing the analysis, after which the video must then be recorded. Care must be taken when implementing post-processing procedures, as some conventional approaches can produce visible artifacts. Moreover, identifying the dark areas of a video may require computationally intense content analysis. What is needed is an improved methodology for efficiently removing dark peripheries of videos that have been captured in low-light environments. What is also needed is an improved methodology for providing automatic zooming of videos that have been captured in low-light environments.

### BRIEF SUMMARY

Pursuant to one set of exemplary embodiments, a method of performing automatic interactive area of visibility video zooming for low light environments is provided. The method includes defining a first set of candidate frame perimeters comprising a subset of one or more frames of recorded video based upon a cropping threshold for cropping the one or more frames. A first brightness value is determined within the first set of candidate frame perimeters for the one or more frames. In response to the first brightness value being above a minimum brightness threshold, all content outside of the first set of candidate frame perimeters is not displayed, or only some or all of the content within the first set of candidate frame perimeters is displayed. In response to the first brightness value being at or below the minimum brightness threshold, a second set of candidate frame perimeters are defined which comprise a subset of the first set of candidate frame perimeters. A second brightness value is determined within the second set of candidate frame perimeters. In response to the second brightness value being above the minimum brightness threshold, all content outside of the second set of candidate frame perimeters is not displayed, or only some or all of the content within the second set of candidate frame perimeters is displayed. In response to the second brightness value being at or below the minimum brightness threshold, a third set of candidate frame perimeters are defined which comprise a subset of the second set of candidate frame perimeters.

Pursuant to another set of exemplary embodiments, a method of performing automatic interactive area of visibility video zooming for low light environments is provided. The method includes defining a set of two or more candidate points or pixels within one or more frames of recorded video. A threshold brightness value is defined at or above which a point or a pixel of the set of two or more candidate points or pixels is classified as being a bright point, and below which a point or a pixel of the set of two or more candidate points or pixels is classified as being a dark point. A threshold quantity of bright points and a threshold quantity of dark points are defined. A brightness value is determined for each point in the set of two or more candidate points to classify each point as either a bright point or a dark point. A first quantity of points that were classified as bright points is calculated, and a second quantity of points that were classified as dark points is calculated. When the calculated first quantity of points is above the threshold quantity of bright points, a first set of lines is defined that intersects all points classified as bright points, wherein the first set of lines defines a bright perimeter. When the calculated second quantity of points is above the threshold quantity of dark points, a second set of lines is defined that intersects all points classified as dark points, wherein the second set of lines defines a dark perimeter. One or more frames of recorded video is cropped using at least one of the bright perimeter as the outermost perimeter to be included or the innermost dark perimeter to be excluded, such that video content which is in the bright perimeter is included and retained in the cropped video, but he video content which is in the dark perimeter is removed by the cropping. For example, if the two outermost perimeters are determined to be dark and the third perimeter is determined to be bright, then the resulting video will include all of the region corresponding to the bright perimeter as well as the region that is inside the bright perimeter.

Pursuant to another set of exemplary embodiments, a computer program product for performing automatic interactive area of visibility video zooming for low light environments is provided. The computer program product includes at least one computer-readable storage medium having computer-executable program code instructions stored therein. The computer-executable program code instructions may include program code instructions for defining a first set of candidate frame perimeters comprising a subset of one or more frames of recorded video based upon a cropping threshold for cropping the one or more frames. A first brightness value is determined within the first set of candidate frame perimeters for the one or more frames. In response to the first brightness value being above a minimum brightness threshold, all content outside of the first set of candidate frame perimeters is not displayed, or only some or all of the content within the first set of candidate frame perimeters is displayed. In response to the first brightness value being at or below the minimum brightness threshold, a second set of candidate frame perimeters are defined which comprise a subset of the first set of candidate frame perimeters. A second brightness value is determined within the second set of candidate frame perimeters. In response to the second brightness value being above the minimum brightness threshold, all content outside of the second set of candidate frame perimeters is not displayed, or only some or all of the content within the second set of candidate frame perimeters is displayed. In response to the second brightness value being at or below the minimum brightness threshold, a third set of candidate frame perimeters are defined which comprise a subset of the second set of candidate frame perimeters.

Pursuant to another set of exemplary embodiments, a computer program product for performing automatic interactive area of visibility video zooming for low light environments is provided. The computer program product includes at least one computer-readable storage medium having computer-executable program code instructions stored therein. The computer-executable program code instructions may include program code instructions for defining a set of two or more candidate points or pixels within one or more frames of recorded video. A threshold brightness value is defined at or above which a point or a pixel of the set of two or more candidate points or pixels is classified as being a bright point, and below which a point or a pixel of the set of two or more candidate points or pixels is classified as being a dark point. A threshold quantity of bright points and a threshold quantity of dark points are defined. A brightness value is determined for each point in the set of two or more candidate points to classify each point as either a bright point or a dark point. A first quantity of points that were classified as bright points is calculated, and a second quantity of points that were classified as dark points is calculated. When the calculated first quantity of points is above the threshold quantity of bright points, a first set of lines is defined that intersects all points classified as bright points, wherein the first set of lines defines a bright perimeter. When the calculated second quantity of points is above the threshold quantity of dark points, a second set of lines is defined that intersects all points classified as dark points, wherein the second set of lines defines a dark perimeter. One or more frames of recorded video is cropped using at least one of the bright perimeter as the outermost perimeter to be included or the innermost dark perimeter to be excluded, such that video content which is in the bright perimeter is included and retained in the cropped video, but he video content which is in the dark perimeter is removed by the cropping.

Pursuant to another set of exemplary embodiments, an apparatus for performing automatic interactive area of visibility video zooming for low light environments is provided. The apparatus may include at least one processor and at least one memory including computer program code. The at least one memory and the computer program code may be configured to, with the at least one processor, cause the apparatus to perform at least defining a first set of candidate frame perimeters comprising a subset of one or more frames of recorded video based upon a cropping threshold for cropping the one or more frames. A first brightness value is determined within the first set of candidate frame perimeters for the one or more frames. In response to the first brightness value being above a minimum brightness threshold, all content outside of the first set of candidate frame perimeters is not displayed. In response to the first brightness value being at or below the minimum brightness threshold, a second set of candidate frame perimeters are defined which comprise a subset of the first set of candidate frame perimeters. A second brightness value is determined within the second set of candidate frame perimeters. In response to the second brightness value being above the minimum brightness threshold, all content outside of the second set of candidate frame perimeters not displayed. In response to the second brightness value being at or below the minimum brightness threshold, a third set of candidate frame perimeters are defined which comprise a subset of the second set of candidate frame perimeters.

Pursuant to another set of exemplary embodiments, an apparatus for performing automatic interactive area of visibility video zooming for low light environments is provided. The apparatus may include at least one processor and at least one memory including computer program code. The at least one memory and the computer program code may be configured to, with the at least one processor, cause the apparatus to perform at least defining a set of two or more candidate points or pixels within one or more frames of recorded video. A threshold brightness value is defined at or above which a point or a pixel of the set of two or more candidate points or pixels is classified as being a bright point, and below which a point or a pixel of the set of two or more candidate points or pixels is classified as being a dark point. A threshold quantity of bright points and a threshold quantity of dark points are defined. A brightness value is determined for each point in the set of two or more candidate points to classify each point as either a bright point or a dark point. A first quantity of points that were classified as bright points is calculated, and a second quantity of points that were classified as dark points is calculated. When the calculated first quantity of points is above the threshold quantity of bright points, a first set of lines is defined that intersects all points classified as bright points, wherein the first set of lines defines a bright perimeter. When the calculated second quantity of points is above the threshold quantity of dark points, a second set of lines is defined that intersects all points classified as dark points, wherein the second set of lines defines a dark perimeter. One or more frames of recorded video is cropped using at least one of the bright perimeter as the outermost perimeter to be included or the innermost dark perimeter to be excluded, such that video content which is in the bright perimeter is included and retained in the cropped video, but he video content which is in the dark perimeter is removed by the cropping.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1A is a block diagram illustrating a first mobile device for performing automatic interactive area of visibility video zooming for low light environments according to various exemplary embodiments of the present invention.

FIG. 1B is a block diagram illustrating a second mobile device for performing automatic interactive area of visibility video zooming for low light environments according to various exemplary embodiments of the present invention.

FIG. 1C is a block diagram illustrating an apparatus for performing automatic interactive area of visibility video zooming for low light environments according to various exemplary embodiments of the present invention.

FIGS. 2A and 2B together comprise a logic flow diagram that illustrates the operation of a first exemplary method, and a result of execution of computer program instructions embodied on a computer readable memory, for performing automatic interactive area of visibility video zooming for low light environments in accordance with various exemplary embodiments of the present invention.

FIG. 3 is a logic flow diagram that illustrates the operation of a second exemplary method, and a result of execution of computer program instructions embodied on a computer readable memory, for performing automatic interactive area of visibility video zooming for low light environments in accordance with various exemplary embodiments of the present invention.

FIGS. 4A and 4B each illustrate a set of exemplary candidate frame perimeters and a set of exemplary candidate points for providing performing automatic interactive area of visibility video zooming for low light environments in accordance with a set of illustrative embodiments of the invention.

FIGS. 5A and 5B illustrate the processing of an exemplary frame comprising a video image in accordance with any of the techniques described in conjunction with FIGS. 2A, 2B, 3, and 4A.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Electronic devices have been rapidly developing in relation to their communication and content sharing capabilities. As the capabilities of such devices have increased, applications and services have grown to leverage the capabilities to provide increased utility and improved experience for users. Social networks and various services and functionalities supporting social networks are examples of mechanisms developed to leverage device and network capabilities to provide users with the ability to communicate with each regarding shared experiences.

As such, users of social networking applications often use the social network as a mechanism by which to distribute content to others. Moreover, in some situations, a plurality of users belonging to the same social group, or at least being associated with a common service, may experience similar phenomena or events and independently generate content associated therewith. For example, in some cases, there may be a number of individuals recording or generating content at or near a particular event such as a social gathering, political event, concert or sporting event. Each of the individuals may have different devices that may have respective different performance capabilities. Additionally, each of the individuals may have a different perspective on the events. Accordingly, it may be advantageous to pool together bits of content from various ones of the individuals into a collage or combination of content that can be shared with some or all participants. This type of media combination is sometimes referred to as generating a “director's cut”.

The use of a service that may assist with the generation of a director's cut often relies on the uploading or submission of the recorded content to a central location such as a server. For example, each participant may first record media content (e.g., audio and/or video, images, etc.) associated with an event at his or her mobile device. Each participant may then upload a full recording of the media content recorded by the mobile device of the corresponding participant to the service (e.g., to the server). The service may then use the multiple different uploaded files to select portions from different files in order to generate a remixed or summary content item to form the director's cut.

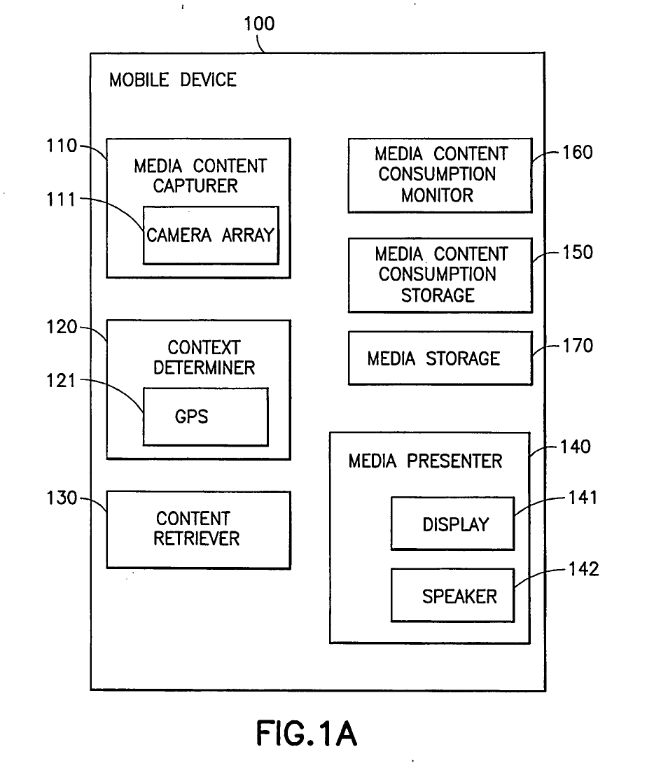

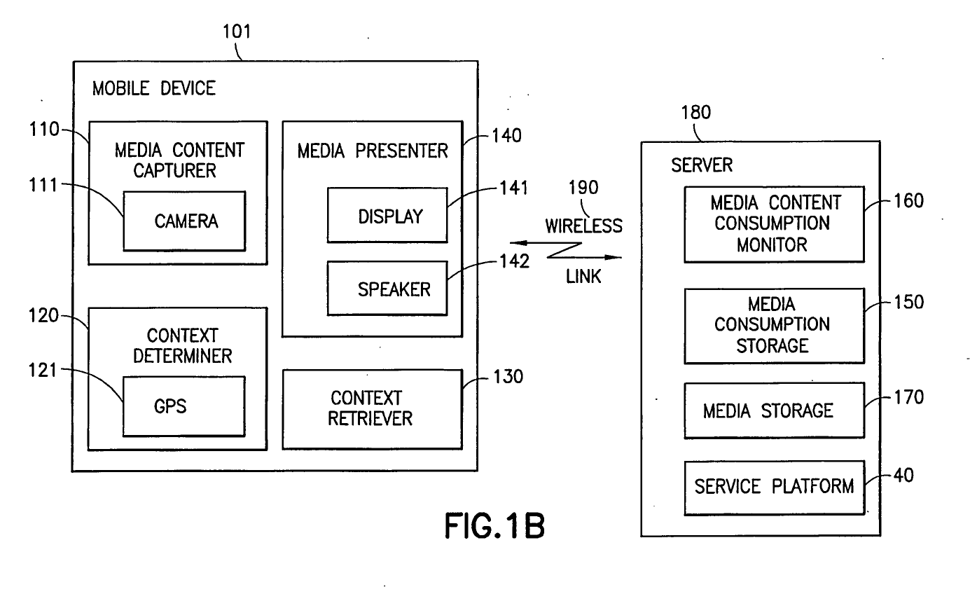

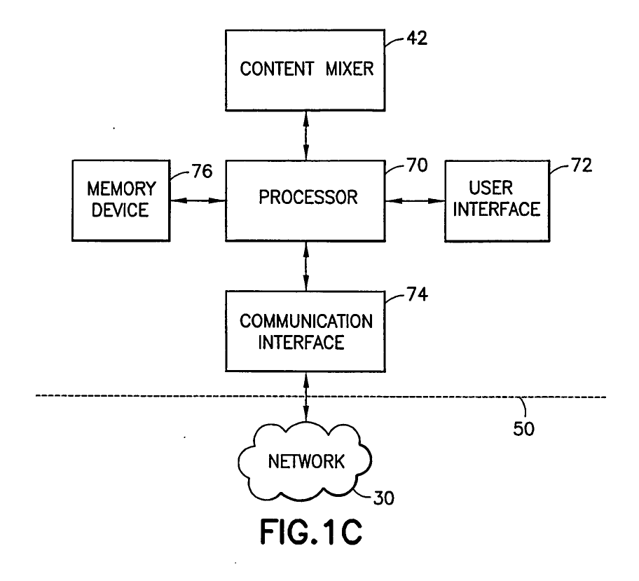

FIG. 1A is a block diagram illustrating a mobile device 100 for performing automatic interactive area of visibility video zooming for low light environments according to a first set of embodiments of the invention. However, as will be described hereinafter with reference to FIG. 1B, some or all of the elements of the invention may be distributed on a data communications network or provided on a computer. The mobile device 100 (FIG. 1A)—as well as a mobile device 101 illustrated in FIG. 1B—may be a mobile telephone, smart phone, personal digital assistant, portable computer, laptop computer, mobile communication device, audio/video player, digital camera, camcorder, positioning device such as a GPS device (Global Positioning System), mobile TV, or the like, or any combination of the aforementioned.

The mobile device 100 of FIG. 1A comprises a media content capturer 110 that is configured to capture media content at a current location and current vantage point of the mobile device 100. The media content capturer 110 comprises a camera configured to perform the capturing of the media content by capturing a set of one or more still images, or a full-motion video clip, or both, at the current location and vantage point of the mobile device 100. Optionally, the mobile device 100 may include a transducer for recording audio associated with the media content. For example, the media content may be a live video or audiovisual stream captured by a user of the mobile device 100 with the camera 111. However, the media content need not necessarily be live. For example, the media content may be captured by first recording the media content and then viewing the content at a later time. As indicated previously, the media content need not necessarily be a video or audiovisual stream. Rather, the media content may be, for example, one or more still images.

The camera 111 of the mobile device 100 is equipped with a display screen that can be used as a viewfinder for the digital camera. For example, a media presenter 140 and an included display 141 may be used as a viewfinder with which the user may view the media content as it is being captured. The display 141 may also be used to display real-time, interactive video remixes.

It is to be understood that the camera 111 need not necessarily be physically integrated in the mobile device 100. Rather, the camera 111 may optionally be a physically separate device (not illustrated) communicating with the mobile device 100 in a suitable manner, e.g. via a Bluetooth connection (not illustrated). If the camera 111 is a physically separate device, the display 141 is illustratively provided by the mobile device 100, and the camera 111 optionally may be equipped with one or more integrated viewfinders separate from the mobile device 100.

The mobile device 100 includes a context determiner 120 configured to determine a current context of the mobile device 100, wherein the current context includes at least the current location and the current vantage point of the mobile device 100. It is to be understood that the term “current” is used herein to refer to “at the time of capturing the media content”. The vantage point is the perspective or physical orientation of the camera relative to the media content being captured.

The current context of the mobile device 100 may further comprise at least one of: a current date, a current geographic location, a season/time of year at the current geographic location, an identification perimeter for a user of the camera 111 or mobile device 100, a physical orientation of the mobile device 100 or the camera 111 while capturing the media content, and a zoom ratio of the mobile device 100 or camera 111 while capturing the media content. Furthermore, as will be described in more detail hereinafter, the mobile device 100 may be provided information about past media content consumption of the user of the mobile device 100 over a period of time in which case this information may also be included in the current context of the mobile device 100.

As illustrated in FIG. 1A, the context determiner 120 may comprise a Global Positioning System (GPS) receiver 121 configured to provide the current location of the mobile device 100. Alternatively, the current location of the mobile device 100 may be determined with positioning via cell identification or positioning via access point.

The vantage point or orientation of the mobile device 100 or the camera 111 may be determined with reference to a direction, axis, or bearing along which the mobile device 100 is oriented or pointed while capturing media content. Alternatively or additionally, the vantage point may comprise a direction, axis, or bearing along which the camera 111 is oriented or pointed while capturing media content. Furthermore, the orientation of the mobile device 100 may include a physical alignment that the mobile device 100 and particularly the camera 111 are tilted at with respect to a reference axis or reference plane while capturing the media content. The vantage point or orientation of the camera 111 or mobile device 101 may be regarded as the direction in which the camera 111 or mobile device 101 is facing. For example, the direction may be determined using an electronic compass (not illustrated) with which the context determiner 120 is equipped. The alignment may be determined, for example, using a suitable sensor device (not illustrated) with which the context determiner 120 is equipped.

Optionally, the camera 111 may be configured to sense or register a zoom ratio for the camera 111. The zoom ratio is registered with the context determiner 120. The identification of the user of the mobile device 100 may, but need not, be a telephony subscriber identification of the user in case the mobile device 100 is a mobile telephone. Alternatively or additionally, the identification of the user may be an identification generated and used specifically for context-based media presentation.

The mobile device 100 includes a media storage 170 which, for illustrative purposes, is a database configured to store media content. The media content may comprise, for example, one or more video clips, audio clips, still images, or any of various combinations thereof. The mobile device 100 optionally comprises a media content consumption monitor 160 that is configured to monitor the media content consumption of the user of the mobile device 100 over a period of time. Furthermore, the mobile device 100 may include an optional media content consumption storage 150 that is configured to store information (e.g. a log file) about the media content consumption of the user. Thus, the media content consumption monitor 160 and the media content consumption storage 150 allow the user's media content consumption history to be known.

The mobile device 100 includes a content retriever 130 that is configured to provide interactive, real-time video remixing in response to an input received from a user. The content retriever 130 is configured to retrieve media content from media storage 170 of the mobile device 100 as well as additional media content gathered by one or more other mobile devices wherein the additional media content is communicated to the mobile device 100 over a communications network. The mobile device 100 also includes a media presenter 140 configured to present media content retrieved by the content retriever 130. Illustratively, the media presenter 140 further comprises the display 141 and a speaker 142.

FIG. 1B is a block diagram illustrating a mobile device 101 according to a second set of embodiments of the invention. The embodiments of FIG. 1B differ from the embodiments of FIG. 1A in the disposition of the various elements 110 to 170. More specifically, as opposed to being arranged in the mobile device 101, the embodiments of FIG. 1B provide the media content consumption storage 150, the media content consumption monitor 160, and the media storage 170 in a server 180. However, the functionality of the elements 110 to 170 in the embodiments of FIG. 1B are similar or identical to those of the elements 110 to 170 in the embodiments of FIG. 1A.

The server 180 (FIG. 1B) may be arranged in a network (not illustrated), such as the Internet, a wireless network, a data network or any other type of communications network. The mobile device 101 and the server 180 communicate via a wireless link 190 that may, but need not, comprise a mobile telecommunications network with data transfer capabilities, such as a General Packet Radio Service (GPRS) or Third Generation Partnership Project (3GPP) data link. Alternatively or additionally, the wireless link 190 may comprise a Wireless Local Area Network (WLAN) link, a radio frequency (RF) link, a Bluetooth (BT) link, an Infrared (IR) link, or any of a number of different communication techniques, including Worldwide Interoperability for Microwave Access (WiMAX), WiFi, ultra-wide band (UWB), Wibree techniques and/or the like.

It is to be understood that the media content consumption storage 150, the media content consumption monitor 160, and the media storage 170 could, but need not, be provided using a single server. For example, zero, one, or more than one of the media content consumption storage 150, the media content consumption monitor 160, and the media storage 170 may be arranged in some other network element(s), such as another server (not illustrated). Alternatively, one or two of the media content consumption storage 150, the media content consumption monitor 160, and the media storage 170 may be provided by the mobile device 101 while the remaining items are distributed into the server 180.

Regardless of the specific form of instantiation of the devices involved, various embodiments of the present invention may relate to the provision of access to content within the context of a social network or other set of individuals including a defined group of users and/or the devices of the users. The group may be predefined based on any of a number of ways that a particular group may be formed. In this regard, for example, invited members may accept invitations to join the group, applications may be submitted and accepted applicants may become group members, or a group membership manager may define a set of users to be members of a group. Thus, for example, group members could be part of a social network or may be associated with a particular service such as a service hosted by or associated with a service platform 40 (FIG. 1B). Accordingly, it should be appreciated that, although FIGS. 1A and 1B show exemplary devices capable of communication, some embodiments may include groups like social networks with the potential for many more group members and corresponding devices. Thus, FIGS. 1A and 1B should not be seen as being limiting in this regard.

With reference to FIG. 1B, the service platform 40 may be a device or node such as a server or other processing circuitry. The service platform 40 may have any number of functions or associations with various services. As such, for example, the service platform 40 may be a platform such as a dedicated server, backend server, or server bank associated with a particular information source, function or service. Thus, the service platform 40 may represent one or more of a plurality of different services or information sources. The functionality of the service platform 40 may be provided by hardware and/or software components configured to operate in accordance with known techniques for the provision of information to users of communication devices, except when modified as described herein.

In a set of exemplary embodiments, the service platform 40 may provide, among other things, content management, content sharing, content acquisition and other services related to communication and media content. Nokia Suite™ and Zune™ are two illustrative examples of service provision mechanisms that may be associated with the service platform 40. In some cases, the service platform 40 may include, be associated with, or otherwise be functional in connection with a mechanism for generating a video remix such as a content mixer 42 (FIG. 1C, to be described in greater detail hereinafter). However, the video remix could alternatively be generated at one or more of the mobile devices 100 and 101 (FIGS. 1A and 1B). For example, in some cases a network could be formed using a plurality of mobile devices 100 to create an ad hoc, peer-to-peer (P2P) network in which a video remix is generated using at least one of the devices forming the P2P network. Illustratively, the service platform 40 (FIG. 1B) may be configured to distribute video remixes to one or more mobile devices 100 corresponding to all or selected group members.

In a set of exemplary embodiments, the service platform 40 may be associated with the provision of functionality and services associated with social networking. Thus, for example, the service platform 40 may include functionality associated with enabling group members to share social interaction media with each other. As such, the service platform 40 may act as or otherwise include a social content server or another social networking server for providing the social interaction media to group members based on individual participant media submissions from various ones of the group members. However, the service platform 40 need not necessarily perform social networking functions in all cases.

FIG. 1C illustrates a schematic block diagram of an apparatus for providing a locally generated video remix using a camera array according to a set of exemplary embodiments of the invention. The apparatus 50 of FIG. 1C may be employed, for example, to implement one or more communication devices such as the mobile device 100 (FIG. 1A), the mobile device 101 (FIG. 1B), the server 180, the service platform 40, or any of various combinations thereof. Alternatively or additionally, various embodiments may be employed where the apparatus 50 of FIG. 1C is distributed on a combination of devices. Accordingly, some embodiments of the present invention may be implemented wholly at a single device such as the mobile device 100 (FIG. 1A), the mobile device 101 (FIG. 1B), or the service platform 40. Other embodiments of the present invention may be implemented by any of a plurality of devices that are in a client/server relationship.

Referring now to FIG. 1C, the apparatus 50 may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with various exemplary embodiments of the present invention. For example, the memory device 76 could be configured to buffer input data for processing by the processor 70. Additionally or alternatively, the memory device 76 could be configured to store instructions for execution by the processor 70. In some embodiments, the memory device 76 may also or alternatively store content items (e.g., media content, documents, chat content, message data, videos, music, pictures and/or the like).

As indicated previously, the apparatus 50 may, in some embodiments, be used to implement any of the service platform 40 (FIG. 1B), a portion or component of the service platform 40, the mobile device 101, the mobile device 100, or any other computing device configured to employ an exemplary embodiment of the present invention. However, in some embodiments, the apparatus 50 (FIG. 1C) may be embodied as a chip or a chip set. In other words, the apparatus 50 may comprise one or more physical packages such as chips or integrated circuits including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied in hardware as one or more of various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), central processing unit (CPU), a hardware accelerator, a vector processor, a graphics processing unit (GPU), a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In a set of exemplary embodiments, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a content mixing device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

The optional user interface 72 (if employed) may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an example embodiment in which the apparatus is embodied as a server or some other network devices (e.g., the service platform 40), the user interface 72 may be limited, or eliminated. However, in a set of embodiments in which the apparatus is implemented as a communication device, such as the mobile device 100 (FIG. 1A) or the mobile device 101 (FIG. 1B), the user interface 72 (FIG. 1C) may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

The communication interface 74 may be any means such as a device or circuitry embodied in either hardware, or a combination of hardware and software, that is configured to receive and/or transmit data from/to a network 30 and/or any other device or module in communication with the apparatus. In this regard, the communication interface 74 may include, for example, an antenna (or multiple antennas) and supporting hardware and/or software for enabling communications with one or more wireless communication networks. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

In a set of exemplary embodiments, the processor 70 may be embodied as, include or otherwise control a content mixer 42 for generating or providing a video remix. As such, in some embodiments, the processor 70 may be said to cause, direct or control the execution or occurrence of the various functions attributed to the content mixer 42 as described herein. The content mixer 42 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the content mixer 42 as described herein. Thus, in examples in which software is employed, a device or circuitry (e.g., the processor 70 in one example) executing the software forms the structure associated with such means.

In a set of exemplary embodiments, the content mixer 42 may be configured to receive media data, sensor data, and context data from a plurality of mobile terminals including any or all of the mobile device 100 (FIG. 1A), the mobile device 101 (FIG. 1B), and perhaps additional devices as well. The media data includes data pertaining to one or more still images, or one or more moving video clips, or still images as well as moving video. The sensor and context data may include information descriptive of the current status of the device providing the media data (e.g., situation description data), such as the camera array 111 (FIGS. 1A and 1B). Thus, the sensor and context data (or situation description data) may provide information indicative conditions at the device while the device is recording or generating media data. As such, for example, the sensor and context data my provide information indicative of the location of the device, orientation of the device (e.g., tilt, panning angle, etc.), environmental conditions near the device, video shake, and/or data from other sensors (e.g., accelerometers, altimeters, proximity sensors, light sensors, gyroscopes, electronic compasses, GPS devices, etc.). In some cases, the sensor and context data may include information indicative of camera sensor data (e.g., digital/analog gain, brightness, etc.). In some embodiments, the sensor and context data may be raw sensor data that may be processed by the content mixer 42 (FIG. 1C) in order to determine the context of the device from which the sensor and context data was received. However, in other examples, the sensor and context data may be derived sensor data and context data that has been analyzed at the device from which the data was received and has been derived from the analysis of the raw sensor data or context data such as device state or the like.

The sensor and context data may be received by the content mixer 42 substantially in real time (e.g., while media data is being captured) or at some later time. The sensor and context data may be received via any suitable transport protocol (e.g., HTTP, SIP (session initiation protocol), RTP (real-time transport protocol), SMS (short message service), etc.) and in any suitable format (e.g., text, XML (extensible markup language), SDP (session description protocol), BINARY, etc.). The sensor and context data may also include information indicative of an identity of the mobile device from which the sensor and context data was received, information indicative of a time period over which the media data to which the sensor and context data corresponds was gathered, and/or other information about the media data.

In some exemplary embodiments of the invention, the content mixer 42 may optionally be configured to receive media analysis data from various respective devices of the group or set of devices providing data corresponding to a common event. The media analysis data may also be provided by any suitable transport protocol and in any suitable format. The analysis of the media data, from which the media analysis data results, may be accomplished substantially in real time (e.g., while media data is being captured) or at some later time. The transmission of the media analysis to the content mixer 42 may also occur either substantially in real time or at some later time.

The media analysis data may include analysis of captured video, audio, images or other media itself. As such, for example, the media analysis data (e.g., content description data) may include video brightness, shake, panning or tilt detection for the camera 111 (FIGS. 1A and 1B) as performed from content analysis techniques, and/or other content analysis results for a defined video or audio segment or images. The segment size of the defined video or audio segment may be determined in terms of a number of frames or based on start and end times. The media analysis data may also or alternatively include information indicative of recorded audio quality, audio feature extraction (e.g., fingerprints), pre-processing for audio alignment (e.g., extraction of audio features used by an audio alignment algorithm employed in the content mixer 42 (FIG. 1C)), or other audio-related signal processing. Media quality evaluation may be performed relative to a standard or any common quality metric that may be provided by the content mixer 42 to terminals providing data to the content mixer 42 (either before or during recording) so that terminals providing the data can perform media quality evaluations, and in some cases also perform rankings, locally and independently of other terminals while still using common metrics.

In a set of exemplary embodiments, the content mixer 42 may be configured to perform audio time alignment of different clips or files of media data provided from different respective devices based on received audio feature vectors from the media analysis data provided by each respective device. Thus, for example, transmission of full media data files may not be necessary. The performance of pre-processing for audio alignment (e.g., via audio feature extraction) by the devices themselves may not be needed in some cases.

In a set of exemplary embodiments, the content mixer 42 may be configured to utilize the sensor and context data (e.g., device situation description data) and the media analysis data (e.g., content description data) received from each contributing device to select specific portions of the media data recorded at selected ones of the contributing devices. The content mixer 42 may be configured to then request the specific portions from the selected ones of the contributing devices. The specific portions requested may be selected based on indications of quality, desired location or view, or any other criteria. The specific portions requested may be indicated with respect to temporal criteria (e.g., via request of data covering specific time periods or via request of specific data frames) or with respect to other criteria. As an example of other criteria, user feedback may be accounted for with respect to operation of the content mixer 42. For example, if user feedback such as voting data, thumbs up/down, relevance feedback and/or the like may exist with respect to a particular portion of the media data (e.g., one or more media segments) and thereby provide some indication of importance or priority of the corresponding media segments, the content mixer 42 may request data having a priority associated therewith. Conditions for assignment of priority may include, for example, sensor availability (e.g., tri-axial accelerometer, tri-axial magnetometer, gyroscope, GPS, Indoor-positioning sensor, etc), recording device capability (e.g., resolution, frame rate, bit rate, codec, etc.), network connectivity of the device when the content mixer 42 requests data (e.g., assigning a higher priority to communication over WLAN than communication over a 3G network), and/or the like. Media segments may be requested, and in some cases therefore received also, based on the priority. In some cases, the content mixer 42 may request a single media type or class only (e.g., only video, audio or images), or multiple media types or classes (e.g., audio and video).

After media segments have been requested, the content mixer 42 may wait to receive responses from the devices to which requests were sent. As indicated above, even though a set of devices may each provide sensor and context data along with media analysis data to the content mixer 42, the content mixer 42 may select media segments from a subset of the set of devices. However, in some cases, the content mixer 42 may request media segments from the entire set. The segments requested may represent a non-redundant set of media segments that can be combined to provide coverage of an entire range of times or frames for which production of a composite or summary media file of mixed content is desired. However, in other cases, the content mixer 42 may request some overlapping content or redundant media segments. The redundant media segments may be useable for split screen views, composite views or to ensure that enough data is received without submitting additional requests in case some devices to which requests are sent do not respond or in cases where some devices have been found to be on low bandwidth network. In cases where a particular device to which a request is sent, but no response is received (either at all or within a predetermined time limit), the content mixer 42 may request a corresponding media segment from another device. The request may be issued to a device having high priority data covering the corresponding frames or time period, or to a device that has demonstrated reliability by providing media segments already.

After all or sufficient ones of the requested media segments have been received by the content mixer 42, the content mixer 42 may be configured to produce mixed content as a summary or composite of the media segments received. In some cases, the content mixer 42 may even produce the mixed content with less than all of the requested media segments being received. After the content mixer 42 has produced the mixed content, the content mixer 42 may publish the mixed content at a location that is accessible to the contributing devices (and/or perhaps also additional or other devices). Alternatively or additionally, the content mixer 42 may transmit the mixed content to the contributing devices (and/or perhaps also additional or other devices). In some embodiments, the content mixer 42 may request other media segments, and in some cases all remaining portions of the media segments not sent previously, in order to complete uploading of the media data in a less time critical fashion. In some cases, the additional requests may be governed by priorities or rules established for the content mixer 42 by one or more users, by the group, or by a network entity.

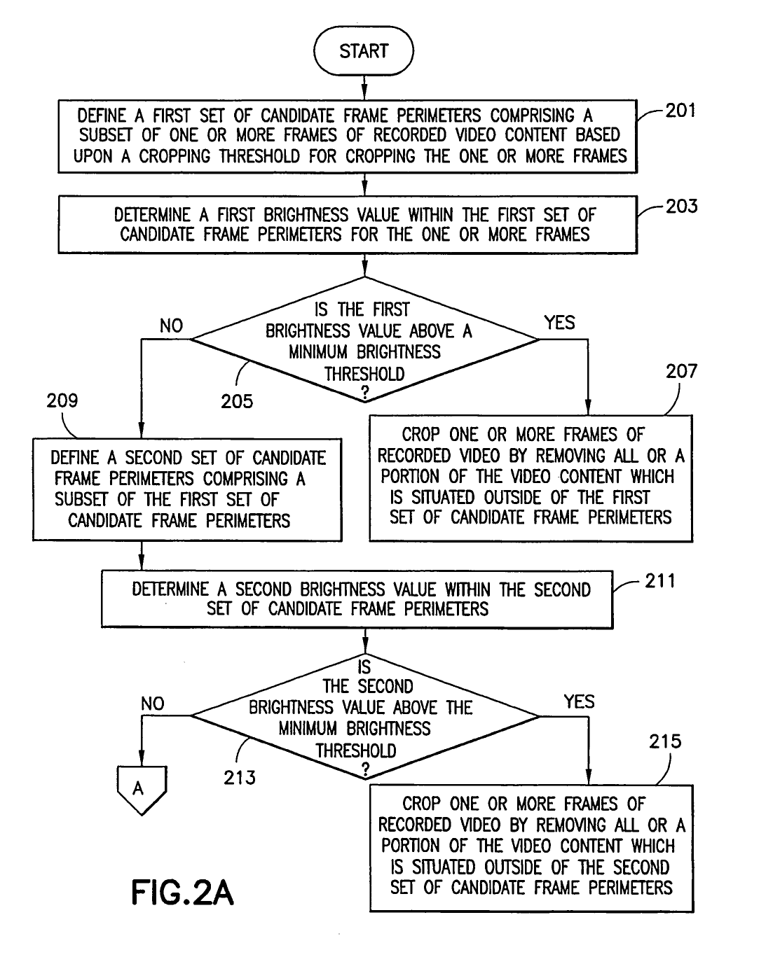

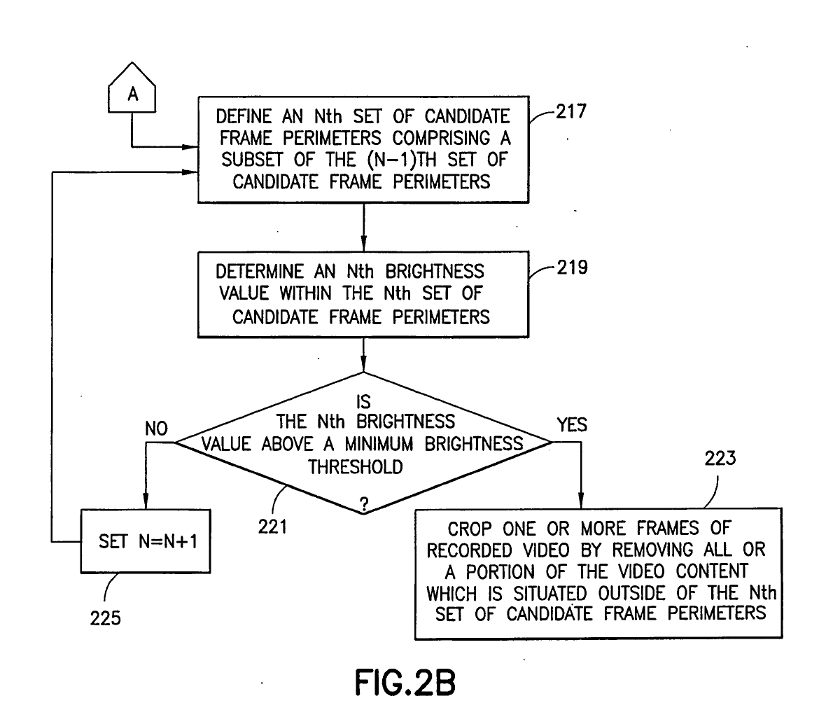

FIGS. 2A and 2B together comprise a logic flow diagram that illustrates the operation of a first exemplary method, and a result of execution of computer program instructions embodied on a computer readable memory, for performing automatic interactive area of visibility video zooming for low light environments in accordance with various exemplary embodiments of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowcharts block(s).

These computer program instructions may also be stored in a non-transitory computer-readable storage memory that may direct a computer or other programmable apparatus to function in a particular manner, such that the instructions stored in the computer-readable storage memory produce an article of manufacture including means which implement the function specified in the flowcharts block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts block(s).

Accordingly, blocks of the flowcharts support combinations of means for performing the specified functions, combinations of operations for performing the specified functions and program instructions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

The operational sequence of FIGS. 2A and 2B commences at block 201 (FIG. 2A) where a first set of candidate frame perimeters are defined. The candidate frame perimeters comprise a subset of one or more frames of recorded video content based upon a cropping threshold for cropping the one or more frames. Next, at block 203, a first brightness value is determined within the first set of candidate frame perimeters for the one or more frames. A test is performed at block 205 to ascertain whether or not the first brightness value is above a minimum brightness threshold. If so, one or more frames of recorded video are cropped by removing all or a portion of the video content which is situated outside of the first set of candidate frame perimeters (block 207). Alternatively or additionally, cropping is performed by removing all video content outside of a predefined number of pixels beyond the first set of candidate frame perimeters.

The negative branch from block 205 leads to block 209 where a second set of candidate frame perimeters are defined which comprise a subset of the first set of candidate frame perimeters. Next, a second brightness value is determined within the second set of candidate frame perimeters (block 211). A test is performed at block 213 to ascertain whether or not the second brightness value of block 211 is above the minimum brightness threshold. If so, one or more frames of the recorded video are cropped by removing all or a portion of the video content which is situated outside of the second set of candidate frame perimeters (block 215).

The negative branch from block 213 leads to block 217 (FIG. 2B) where an Nth set of candidate frame perimeters is defined comprising a subset of the (N−1)th set of candidate frame perimeters, N being a non-negative integer greater than or equal to zero. For example, if N=3, a third set of candidate frame perimeters is defined at block 217 which comprise a subset of the second set of candidate frame perimeters. Next, at block 219, an Nth brightness value is determined within the Nth set of candidate frame perimeters. A test is performed at block 221 to ascertain whether or not the Nth brightness value is above the minimum brightness threshold. If so, one or more frames of recorded video are cropped by removing all or a portion of the video content which is situated outside of the Nth set of candidate frame perimeters (block 223). The negative branch from block 221 leads to block 225 where N is set to equal N+1, thus incrementing N by one. The operational sequence then loops back to block 217 which was discussed previously.

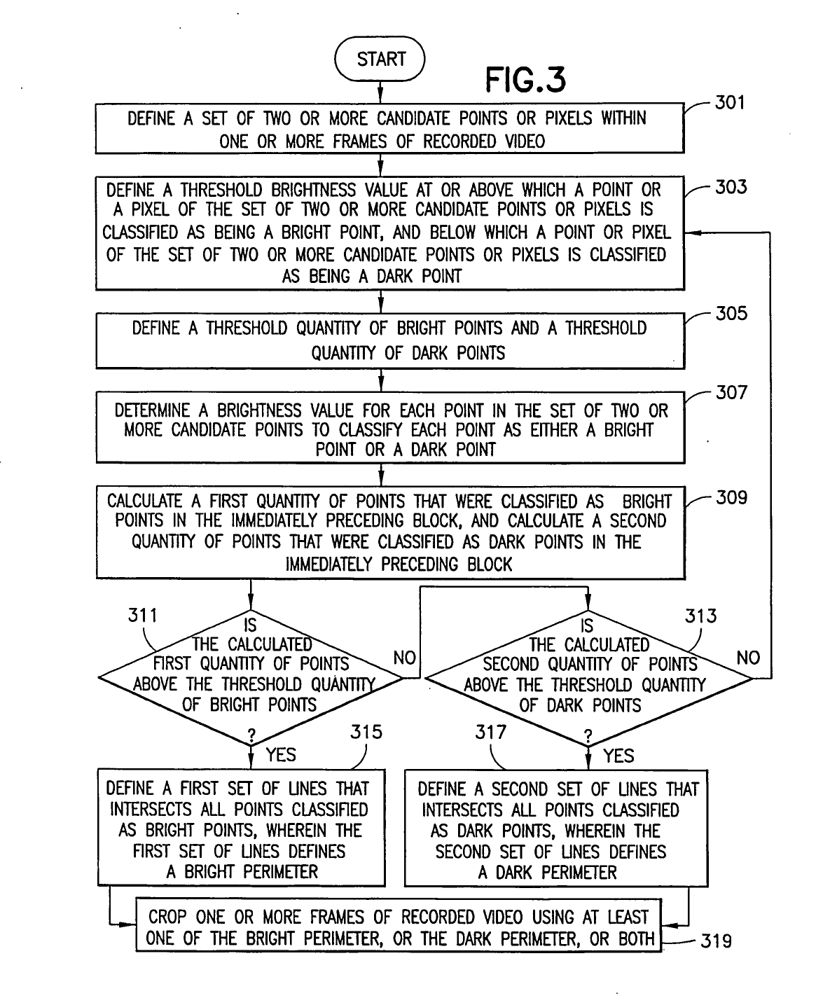

FIG. 3 is a logic flow diagram that illustrates the operation of a second exemplary method, and a result of execution of computer program instructions embodied on a computer readable memory, for performing automatic interactive area of visibility video zooming for low light environments in accordance with various exemplary embodiments of the present invention. The operational sequence of FIG. 3 commences at block 301 where a set of two or more candidate points or pixels is defined within one or more frames of recorded video. Next, at block 303, a threshold brightness value is defined at or above which a point or a pixel of the set of two or more candidate points or pixels is classified as being a bright point, and below which a point or pixel of the set of two or more candidate points or pixels is classified as being a dark point. A threshold quantity of bright points as well as a threshold quantity of dark points are defined (block 305). The threshold quantity of bright points may, but need not, be equal to the threshold quantity of dark points.

The operational sequence of FIG. 3 progresses to block 307 where a brightness value is determined for each point in the set of two or more candidate points to classify each point as either a bright point or a dark point. A first quantity is calculated specifying a quantity of points that were classified as bright points in the immediately preceding block (block 305), and a second quantity is calculated specifying a quantity of points that were classified as dark points in the immediately preceding block. Illustratively, the operational sequence progresses to block 311. Alternatively, the order of blocks 311 and 313 may be reversed such that the operational sequence may progress directly from block 309 to block 313, or the operational sequence may perform the operations of blocks 311 and 313 contemporaneously. At block 311, a test is performed to ascertain whether or not the calculated first quantity of points is above the threshold quantity of bright points. If so, a first set of lines is defined that intersects all points classified as bright points, wherein the first set of lines defines a bright perimeter (block 315). Next, at block 319, one or more frames of recorded video is then cropped using at least one of the bright perimeter determined at block 315 or a dark perimeter determined at block 317 (to be described hereinafter). Optionally, the camera may display the cropped bright area, eliminating or removing the dark borders, performing an automatic zooming. This automatic zooming operation may, but need not, be performed substantially in real time.

The negative branch from block 311 leads to block 313 where a test is performed to ascertain whether or not the calculated second quantity of points is above the threshold quantity of dark points. If so, the operational sequence progresses to block 317 where a second set of lines is defined that intersects all points classified as dark points, wherein the second set of lines defines a dark perimeter. The operational sequence then progresses to block 319 (described previously).

Another set of embodiments of the invention signals the foregoing dark perimeter information to tune a video stabilization procedure as part of a video post-processing scheme. For example, if it is determined that a particular video has dark borders, a higher cropping ratio for video stabilization can be employed at the back end, or by the device itself, or both. Thus, post-processing use of this method provides a higher degree of video stabilization for videos with large borders and is not only useful in terms of implementing cropping. Video stabilization for mobile recorded video is often a requirement for providing a high-quality viewing experience. Additionally or alternatively, the points that are analyzed may be not just those from the captured video frame, but also those in a lower resolution representation of the video frame as, for example, a device viewfinder. The analysis of the points may happen directly in the compressed bit stream by analyzing the syntax of the compressed or semi-decoded bit stream (e.g., after entropy decoding).

Pursuant to a further set of embodiments of the present invention, a brightness value for a given perimeter or candidate point is calculated using a predefined or a fixed number of video frames. The duration or number of these video frames may be determined as a function of a tempo, a speed, a rhythm, or a beat for an audio soundtrack that accompanies the video frames. In cases where the audio soundtrack is a song, lighting changes in the accompanying video may be synchronized to the beat of the song. Setting the duration or number of frames to be greater than a beat interval overcomes the changes in lighting that occur from beat to beat.

Pursuant to a further set of embodiments of the present invention, a focal point or area or region for cropping may be determined based upon receiving interactive input from a user, input from a facial detection or facial recognition method, input from an object detection or object recognition method, or any other suitable criteria. Cropping may, but need not, include optional real-time display on a camera display or display device. If the focus of zoom is off-center, a minimum distance to the frame or image periphery (in height and width) is maintained, and cropping is performed asymmetrically to the other sides or opposite sides of the frame or image. Thus, asymmetric cropping can be used to achieve a desired cropping ratio. Other suitable periphery selection methods may be adopted based upon application requirements or the availability of additional data. For example, if faces or any other object of interest (OOI) is detected, the periphery selection may be performed in a way such that these faces or OOIs are included in the cropped frame or image.

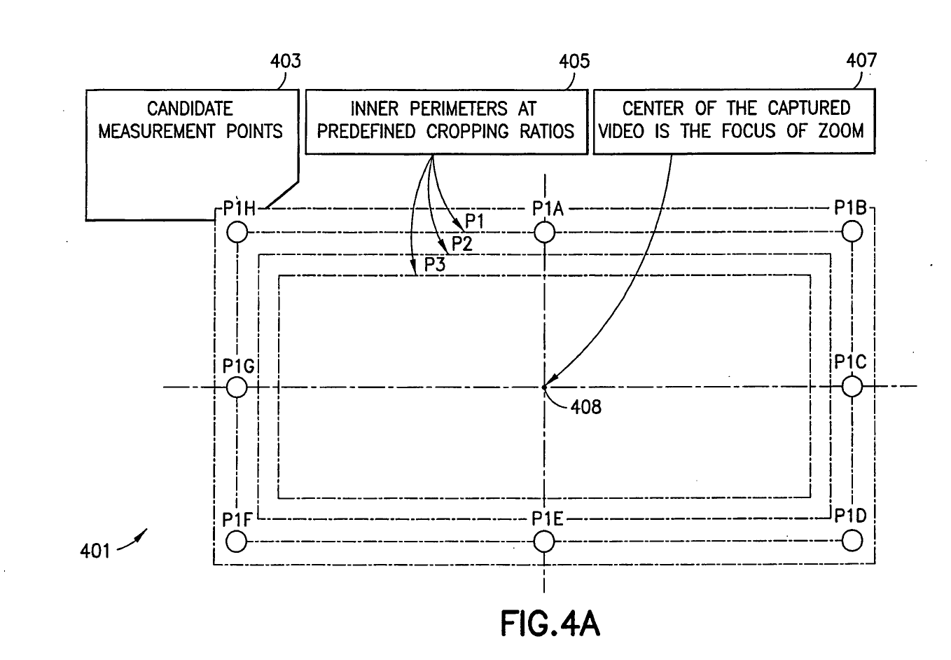

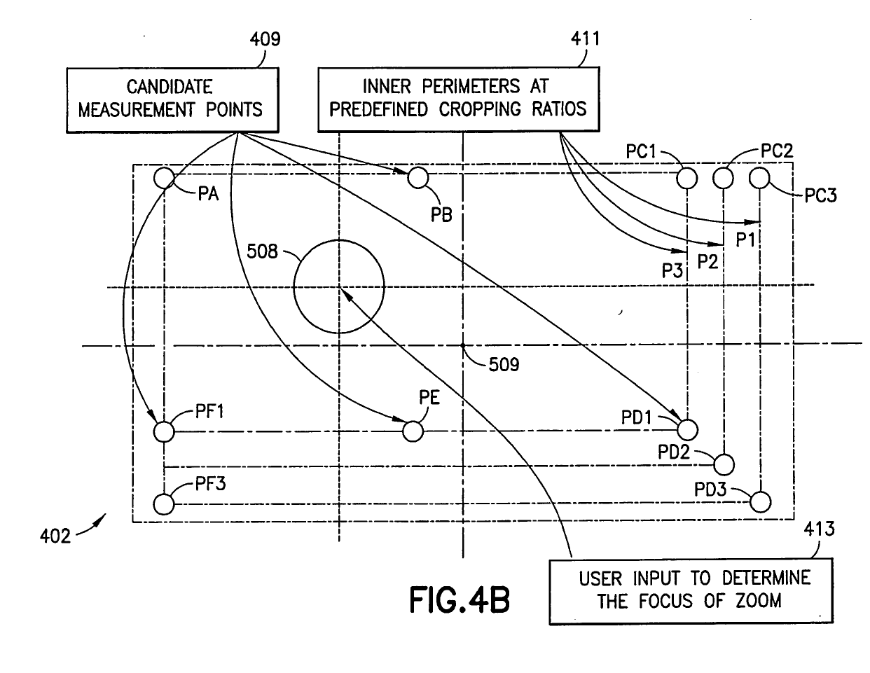

FIGS. 4A and 4B illustrate a first set of exemplary candidate frame perimeters and a first set of exemplary candidate points for providing performing automatic interactive area of visibility video zooming for low light environments in accordance with a set of illustrative embodiments of the invention. The first set of exemplary candidate frame perimeters and the first set of exemplary candidate points may be used in conjunction with any of the operational sequences described with reference to FIGS. 2A, 2B, and 3. Referring now to block 403 of FIG. 4A, candidate measurement points located on one or more inner perimeters P1, P2, and P3 of a frame 401 at predefined cropping ratios are used to calculate brightness. For example, the candidate measurement points may comprise a plurality of pixels P1H, P1G, P1F, P1A, P1E, P1B, P1C, and P1D which are analyzed along the one or more candidate perimeters P1, P2, and P3. At block 405, the inner candidate perimeters P1, P2, and P3 are provided at predefined cropping ratios, illustratively at 90%, 80%, and 70% of the size or area of the frame 401, and these candidate perimeters are used to calculate brightness levels. The pixels P1H, P1G, P1F, P1A, P1E, P1B, P1C, and P1D are each classified as being either bright or dark based on a predefined threshold. Each of these pixels P1H, P1G, P1F, P1A, P1E, P1B, P1C, and P1D has a predefined width.

At block 407, a center point 408 of the frame 401 is considered to be the reference point for determining the inner candidate perimeters P1, P2, and P3. FIG. 4B illustrates an alternate exemplary implementation showing use of an off-center reference point 508 that is located within a frame 402 but not at the center of the frame. At block 409, candidate measurement points including one or more of PA, PB, PC1, PC2, PC3, PD1, PD2, PD3, PE, PF1 or PF3 and located at a predefined cropping ratio are used to calculate brightness. For example, if the predefined cropping ratio is 70%, candidate measuring points PA, PB, PC1, PD, PE, and PF1 are used to calculate brightness. However, with reference to block 411, any of respective inner candidate perimeters P1, P2, and P3 at a corresponding pre-defined cropping ratio such as, for example, 90%, 80%, or 70% of the size or area of the frame 402 may be employed to calculate a brightness value.

Due to an off-center focus corresponding to the off-center reference point 508, it may be observed that inner candidate perimeters P1, P2, and P3 are not symmetric about a center axis or a center point 509, but are selected in such a way so as to maintain an aspect ratio and a desired cropping percentage. At block 413, an input received from a user (for example, a touch-based input, or a focal distance, or a zoom parameter) is used to determine a focus for the camera 111 (FIG. 1A) zoom so that the camera is focused upon the off-center reference point 508 (FIG. 4B). Thus, the off-center reference point 508 may be used in situations where the reference point of the scene is chosen interactively by the user or via some other suitable means.

With regard to block 405 (FIG. 4A) and block 411 (FIG. 4B), if an inner candidate perimeter P1 is found to be dark, the next smallest candidate perimeter P2 is successively chosen for analysis until a pre-defined zooming threshold or limit is reached. The pre-defined zooming threshold depends on one or more of the following: (a) user or application preferences (ex. preference to avoid dark portions at cost of more zooming resulting in relatively increased pixilation); (b) automatic remixing system temporal preference (ex. at a given time, if an automatic remixing system (ARS) will merge multiple views, versus whether only a single view will be used); and (c) zoom without capture quality loss (ex. either due to a larger sensor than the recorded video resolution, or due to optical zoom parameters).

Analyzing only the inner candidate perimeters P1, P2, and P3 of pre-defined pixel width enables bright area envelope analysis to be performed in a manner that reduces or eliminates unnecessary complexity. To overcome the pulsating lights that are common at rock concerts and sports-arenas, a temporal segment of pre-defined length can be used for analyzing and determining an appropriately sized envelope corresponding to bright areas in the recorded scene.

Pursuant to a further set of embodiments, candidate analysis is performed on candidate points P1A, P1B, P1C, P1D, P1E, P1F, P1G, P1H (FIG. 4A) where each point has a pre-defined pixel size. The analysis may be performed at the same pixel position for a pre-defined temporal segment to overcome instantaneous low light conditions caused by pulsating lights in events/concerts.

Pursuant to a further set of embodiments, a temporal segment for candidate perimeter/point analysis is determined on the basis of beat intervals detected from ambient music or sound at a concert or other presentation. This determination advantageously exploits the fact that the lighting changes are usually aligned or associated with the beat, rhythm, or tempo of the music that may accompany the video or still images captured by the camera 111 (FIG. 1A). Pursuant to a still further set of embodiments, in cases where a large sized camera sensor is used, zooming can be enabled without loss of captured video quality.

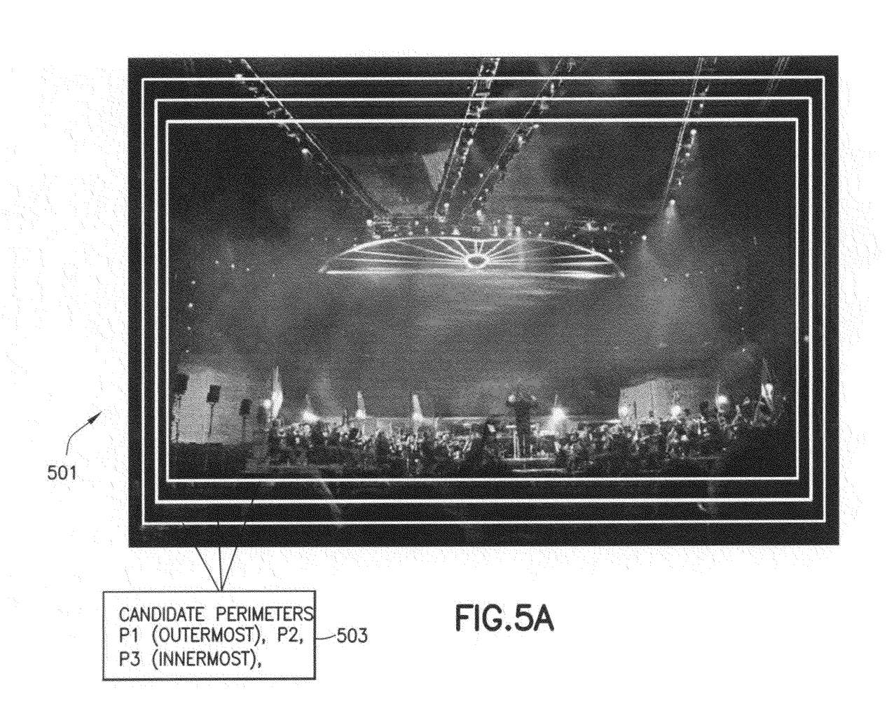

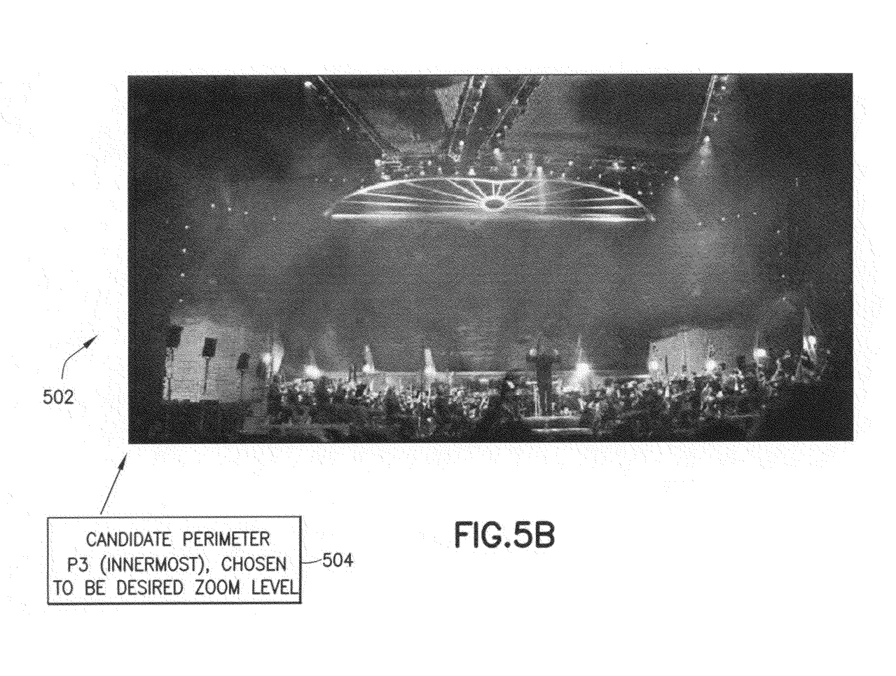

FIGS. 5A and 5B illustrate the processing of an exemplary frame comprising a video image in accordance with the techniques described in conjunction with FIGS. 2A, 2B, 3, and 4A. Referring now to FIG. 5A, a video frame 501 represents a typical video capture produced by camera 111 (FIG. 1A) at an event such as a music concert or other type of event. At block 503, a plurality of candidate perimeters are established including an outermost candidate perimeter P1, a second candidate perimeter P2, and an innermost candidate perimeter P3. FIG. 5B shows a processed video frame 502 representing an outcome, result, or work product generated when the video frame 501 (FIG. 5A) is processed by any of the methods described with reference to FIGS. 2A, 2B, and 3. In the example of FIG. 5B, the processed video frame 502 was created at block 504 by selecting the innermost candidate perimeter P3 of FIG. 5A. Thus, the innermost perimeter P3 (FIGS. 5A and 5B) may be conceptualized as a desired or selected zoom level. One illustrative benefit of the methods discussed with reference to FIGS. 2A, 2B, and 3 is that, as compared to traditional content analysis approaches, audio that accompanies a video scene is utilized while, at the same time, the required computational complexity is reduced.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one memory including computer program code, the at least one memory and the computer program code configured, with the at least one processor, to cause the apparatus at least to perform at least:
defining a first set of candidate frame perimeters comprising a subset of one or more frames of recorded video based upon a cropping threshold for cropping the one or more frames;
determining a first brightness value within the first set of candidate frame perimeters for the one or more frames;
in response to the first brightness value being above a minimum brightness threshold, not displaying content outside of the first set of candidate frame perimeters;
in response to the first brightness value being at or below the minimum brightness threshold, defining a second set of candidate frame perimeters which comprise a subset of the first set of candidate frame perimeters, and determining a second brightness value within the second set of candidate frame perimeters.

2. The apparatus of claim 1 wherein, in response to the first brightness value being above the minimum brightness threshold, removing all content outside of the first set of candidate frame perimeters.

3. The apparatus of claim 1 wherein, in response to the second brightness value being above the minimum brightness threshold, removing all content outside of the second set of candidate frame perimeters.

4. The apparatus of claim 1 wherein, in response to the second brightness value being at or below the minimum brightness threshold, defining a third set of candidate frame perimeters which comprise a subset of the second set of candidate frame perimeters.

5.-6. (canceled)

7. The apparatus of claim 1, wherein the cropping of the one or more frames is performed by selecting a focal point or area or region for cropping based upon receiving one or more of: an input from a user, an input from an object recognition method, an input from a facial recognition method, an input from an object detection method, or an input from a facial detection method.

8. The apparatus of claim 1 further configured to detect one or more objects of interest, wherein the cropping of the one or more frames is performed so as to provide a cropped frame that includes the detected one or more objects of interest.

9. An apparatus comprising at least one processor and at least one memory including computer program code, the at least one memory and the computer program code configured, with the at least one processor, to cause the apparatus at least to perform at least:
defining a set of two or more candidate points or pixels within one or more frames of recorded video, wherein the one or more frames comprise video content;
defining a threshold brightness value at or above which a point or a pixel of the set of two or more candidate points or pixels is classified as being a bright point, and below which a point or a pixel of the set of two or more candidate points or pixels is classified as being a dark point;
defining a threshold quantity of bright points and a threshold quantity of dark points;
determining a brightness value for each point in the set of two or more candidate points to classify each point as either a bright point or a dark point;
calculating a first quantity of points that were classified as bright points, and calculating a second quantity of points that were classified as dark points;
in response to the calculated first quantity of points being above the threshold quantity of bright points, a first set of lines is defined that intersects all points classified as bright points, wherein the first set of lines defines a bright perimeter;
in response to the calculated second quantity of points being above the threshold quantity of dark points, a second set of lines is defined that intersects all points classified as dark points, wherein the second set of lines defines a dark perimeter; and
cropping one or more frames of recorded video to provide a cropped frame using at least one of: (a) the bright perimeter as an outermost perimeter within which video content is included in a cropped frame, or (b) an innermost dark perimeter beyond which video content is removed from the cropped frame.

10.-11. (canceled)

12. The apparatus of claim 9, wherein the cropping of the one or more frames is performed by selecting a focal point or area or region for cropping based upon receiving one or more of: an input from a user, an input from an object recognition method, an input from a facial recognition method, an input from an object detection method, or an input from a facial detection method.

13. The apparatus of claim 9 further configured to detect one or more objects of interest, wherein the cropping of the one or more frames is performed wherein the cropped frame include the detected one or more objects of interest.

14. A method comprising:
defining a first set of candidate frame perimeters comprising a subset of one or more frames of recorded video based upon a cropping threshold for cropping the one or more frames;
determining a first brightness value within the first set of candidate frame perimeters for the one or more frames;
in response to the first brightness value being above a minimum brightness threshold, not displaying all content outside of the first set of candidate frame perimeters;
in response to the first brightness value being at or below the minimum brightness threshold, defining a second set of candidate frame perimeters which comprise a subset of the first set of candidate frame perimeters, and determining a second brightness value within the second set of candidate frame perimeters.

15. The method of claim 14 wherein, in response to the first brightness value being above the minimum brightness threshold, removing all content outside of the first set of candidate frame perimeters.

16. The method of claim 14 wherein, in response to the second brightness value being above the minimum brightness threshold, removing all content outside of the second set of candidate frame perimeters.

17. The method of claim 14 wherein, in response to the second brightness value being at or below the minimum brightness threshold, defining a third set of candidate frame perimeters which comprise a subset of the second set of candidate frame perimeters.

18.-19. (canceled)

20. The method of claim 17, wherein the cropping of the one or more frames is performed by selecting a focal point or area or region for cropping based upon receiving: an input from a user, an input from an object recognition method, an input from a facial recognition method, an input from an object detection method, or an input from a facial detection method.

21. The method of claim 17 further comprising detecting one or more objects of interest, wherein the cropping of the one or more frames is performed so as to provide a cropped frame that include the detected one or more objects of interest.

22. A method comprising:
defining a set of two or more candidate points or pixels within one or more frames of recorded video, wherein the one or more frames comprise video content;
defining a threshold brightness value at or above which a point or a pixel of the set of two or more candidate points or pixels is classified as being a bright point, and below which a point or a pixel of the set of two or more candidate points or pixels is classified as being a dark point;
defining a threshold quantity of bright points and a threshold quantity of dark points;
determining a brightness value for each point in the set of two or more candidate points to classify each point as either a bright point or a dark point;
calculating a first quantity of points that were classified as bright points, and calculating a second quantity of points that were classified as dark points;
in response to the calculated first quantity of points being above the threshold quantity of bright points, a first set of lines is defined that intersects all points classified as bright points, wherein the first set of lines defines a bright perimeter;
in response to the calculated second quantity of points being above the threshold quantity of dark points, a second set of lines is defined that intersects all points classified as dark points, wherein the second set of lines defines a dark perimeter; and
cropping one or more frames of recorded video to provide a cropped frame using at least one of: (a) the bright perimeter as an outermost perimeter within which video content is included in a cropped frame, or (b) an innermost dark perimeter beyond which video content is removed from the cropped frame.

23.-24. (canceled)

25. The method of claim 22, wherein the cropping of the one or more frames is performed by selecting a focal point or area or region for cropping based upon receiving: an input from a user, an input from an object recognition method, an input from a facial recognition method, an input from an object detection method, or an input from a facial detection method.

26. The method of claim 22 further comprising detecting one or more objects of interest, wherein the cropping of the one or more frames is performed wherein the cropped frame includes the detected one or more objects of interest.

27. A computer program product including at least one computer-readable storage medium having computer-executable program code instructions stored therein, the computer-executable program code instructions including program code instructions for at least:
defining a first set of candidate frame perimeters comprising a subset of one or more frames of recorded video based upon a cropping threshold for cropping the one or more frames;
determining a first brightness value within the first set of candidate frame perimeters for the one or more frames;
in response to the first brightness value being above a minimum brightness threshold, not displaying all content outside of the first set of candidate frame perimeters;
in response to the first brightness value being at or below the minimum brightness threshold, defining a second set of candidate frame perimeters which comprise a subset of the first set of candidate frame perimeters, and determining a second brightness value within the second set of candidate frame perimeters.

28. The computer program product of claim 27 wherein, in response to the first brightness value being above the minimum brightness threshold, removing all content outside of the first set of candidate frame perimeters.

29. The computer program product of claim 28 wherein, in response to the second brightness value being above the minimum brightness threshold, removing all content outside of the second set of candidate frame perimeters.

30. (canceled)

31. A computer program product including at least one computer-readable storage medium having computer-executable program code instructions stored therein, the computer-executable program code instructions including program code instructions for at least:
defining a set of two or more candidate points or pixels within one or more frames of recorded video, wherein the one or more frames comprise video content;
defining a threshold brightness value at or above which a point or a pixel of the set of two or more candidate points or pixels is classified as being a bright point, and below which a point or a pixel of the set of two or more candidate points or pixels is classified as being a dark point;
defining a threshold quantity of bright points and a threshold quantity of dark points;
determining a brightness value for each point in the set of two or more candidate points to classify each point as either a bright point or a dark point;
calculating a first quantity of points that were classified as bright points, and calculating a second quantity of points that were classified as dark points;
in response to the calculated first quantity of points being above the threshold quantity of bright points, a first set of lines is defined that intersects all points classified as bright points, wherein the first set of lines defines a bright perimeter;
in response to the calculated second quantity of points being above the threshold quantity of dark points, a second set of lines is defined that intersects all points classified as dark points, wherein the second set of lines defines a dark perimeter; and
cropping one or more frames of recorded video to provide a cropped frame using at least one of: (a) the bright perimeter as an outermost perimeter within which video content is included in a cropped frame, or (b) an innermost dark perimeter beyond which video content is removed from the cropped frame.
